(19) United States
(12) Patent Application Publication
(10) Pub. No.: US 2012/0312951 A1
(43) Pub. Date: Dec. 13, 2012

(54) Air Freight Pallet

(76) Inventor: Wouter Johannes Leedekerken, Papendrecht (NL)

(21) Appl. No.: 13/575,248

(22) PCT Filed: Jan. 26, 2011
(86) PCT No.: PCT/NL11/50046

§ 371 Date: Aug. 27, 2012

(30) Foreign Application Priority Data
Jan. 26, 2010 (NL) 2004150
Aug. 16, 2010 (NL) 2005233

(51) Int. Cl. B65D 19/32; B29C 51/14

(52) U.S. Cl. 248/346.02; 156/212

(57) ABSTRACT

The present invention relates to an air freight pallet (102), comprising a pallet wall part (103) and a pallet edge part (104) on the pallet wall part. At least one of the pallet edge part (104) and the pallet wall part (103) comprises a number of layers of a plastic material.

The present invention relates to an air freight pallet comprising a pallet wall part and a pallet edge part on the pallet wall part.

Such air freight pallets are known for the purpose of transporting goods by means of an aircraft.

Air freight pallets must be strong and light.

Air freight pallets must be strong because of the forces exerted on the air freight pallet by the goods placed on the air freight pallet and because of the forces exerted by loading and unloading devices on the air freight pallets in the commotion during loading and unloading of the aircraft.

Air freight pallets must be light because of the weight the air freight pallets add to the overall weight of the aircraft, and thereby to the fuel costs of a flight.

The invention has for its object, among others, to improve the known air freight pallets in respect of at least one of the stated aspects.

The invention is distinguished for this purpose in that at least one of the pallet edge part and the pallet wall part comprises a number of layers of a plastic material.

In the known air freight pallets both the pallet edge part and the pallet wall part are generally made of aluminium, which is relatively strong and light. The surface of the pallet edge part and the surface of the pallet wall part do however quickly suffer permanent damage, for instance when they come into contact with other air freight pallets or with a transport vehicle as a result of uncontrolled movements during loading and unloading. The pallet wall part and the pallet edge part are also quickly subject to permanent deformation, for instance when the air freight pallet is not uniformly supported as a result of uncontrolled movements during loading and unloading. As a result of such damage and deformation there comes a moment when the known air freight pallets can no longer be used.

The properties of plastic material can be determined by the composition thereof. It should be noted here that in the context of the invention plastic material is also understood to mean plastic composites such as (glass) fibre-reinforced plastics. In an air freight pallet according to the invention it is for instance possible for the surface of the pallet wall part and/or the pallet edge part to be harder than if it were made of aluminium, or conversely more resilient, whereby the surface is less likely to be damaged than in the case of the known air freight pallets. In an air freight pallet according to the invention it is for instance also possible for the pallet edge part and the pallet wall part to have more bending stiffness than if they were made of aluminium, so that they are less likely to deform, or to be more resilient so that plastic deformation thereof is less likely. It is for instance also possible in an air freight pallet according to the invention for the pallet edge part and/or pallet wall part to be lighter than if they were of aluminium.

An air freight pallet according to the invention with a combination of the stated or additional possible improvements is possible particularly by combining plastic materials of different composition and/or different structure with each other. Such an air freight pallet is moreover relatively simple to manufacture. This is discussed further in the description relating to the method according to the invention.

In a favourable embodiment of the air freight pallet according to the invention the pallet wall part and the pallet edge part are formed integrally. This measure makes it possible to avoid the pallet wall part and the pallet edge part detaching from each other, for instance in the case of an excessive or uncontrolled loading of one of these parts. This has the advantage compared to known aluminium air freight pallets, wherein the pallet edge part and the pallet wall part are separate parts nailed together, that the risk of permanent damage to the air freight pallets is reduced. This measure moreover enables a particularly favourable method for manufacturing the air freight pallet according to the invention. This latter is examined further in the description relating to the method according to the invention.

In a further favourable embodiment of the air freight pallet according to the invention, wherein the pallet edge part and the pallet wall part are formed integrally, the pallet edge part is the edge part of a flat board and the pallet wall part is the central part of the flat board enclosed by the pallet edge part, wherein the core of the flat board comprises a core layer with an open structure and a surface layer is arranged as surface on the core. The core layer with the open structure having a surface layer thereon as surface makes it possible for an air freight pallet according to this embodiment to be particularly light and to have exceptional bending stiffness. It is hereby possible to design an air freight pallet having the same or a lighter weight than a known air freight pallet, wherein the bending forces which occur are distributed over a larger part of the air freight pallet than in the case of a known air freight pallet, wherein the bending forces are distributed mainly over the pallet edge part. This has the advantage compared to the known air freight pallets that the pallet edge part can be given a simpler design, i.e. by means of transforming the edge of the flat board instead of forming a separate pallet edge part which is coupled to a separate pallet wall part. The core layer with the open structure with a surface layer thereon as surface is moreover relatively easy to transform into the pallet edge part, whereby this embodiment of the air freight pallet according to the invention is relatively simple to manufacture. This latter is discussed further in the description relating to the method according to the invention. In a particularly favourable embodiment the core layer is of a plastic material. Owing to the wide diversity of possible components of which the plastic material can be composed this makes a core layer possible which complies particularly well with the set requirements. The is also the case for the surface layer, wherein this layer takes a particularly favourable form when it is of a fibre-reinforced plastic material. This latter makes possible a particularly strong surface of the air freight pallet, which can thereby withstand particularly well the forces occurring when the surface comes into contact with other air freight pallets or with a transport vehicle. It is also the case for both the core layer and the surface layer that forming thereof from plastic material makes the transformation of the edge part of the flat board into the pallet edge part relatively simple. This latter is discussed further in the description relating to the method according to the invention. A particularly favourable structure for the core layer is a honeycomb structure.

In a favourable embodiment hereof the core of the flat board also comprises a number of solid core elements, preferably of a plastic material, along the edge of the flat board. This measure makes it possible to strengthen the pallet edge part relative to the pallet wall part. During loading and unloading, so also the transport of air freight pallets and the goods placed thereon, the edge part of an air freight pallet is subject to impact forces as a result of for instance the collision of the pallet edge part of an air freight pallet with the pallet edge part of another air freight pallet, or for instance through collision of the pallet edge part of an air freight pallet with the forks of a fork-lift truck during placing of the forks under the air freight pallet so that it can lifted and transported. The pallet edge part needs to withstand these impact forces to a lesser extent. This measure hereby has the advantage in the first place that the resistance of the pallet edge part to impact forces can be improved. In addition, this measure has the advantage in the case of an air freight pallet according to the present invention, wherein the pallet wall part and the pallet edge part are formed integrally, that the starting material for the air freight pallets can have the same properties at the position of the pallet edge part to be formed and at the position of the pallet wall part to be formed, while the pallet edge part and the pallet wall part have different properties after being formed. This has the advantage that the starting material for the air freight pallet can take a simple form and that the method for forming the pallet edge part and the pallet wall part can be simple, as is elucidated hereinbelow in the description of the method according to the invention. A particularly favourable material for the solid core elements is plastic, in particular polypropylene. It is however also possible to form the solid core elements from solid nylon or aluminium.

In a favourable embodiment of the air freight pallet according to the invention with solid core elements, the solid core elements extend in the core layer with the open structure. This measure enables a particularly good connection between the core layer with the open structure and the solid core elements. In a particularly favourable embodiment hereof the solid core elements are enclosed by the core layer.

In a favourable embodiment of the air freight pallet according to the invention with solid core elements, the core elements are elongate elements which extend in the longitudinal direction thereof along a part of the edge of the flat board. These elongate core elements not only make it possible to increase the resistance of the pallet edge part to impact forces, but also to increase the bending stiffness of the pallet edge part. This latter has the particular advantage that the pallet wall part need contribute less toward the stiffness of the air freight pallet, whereby the pallet wall part can for instance be embodied lighter in weight. A particularly significant contribution toward the bending stiffness of the pallet edge part is achieved when the elongate solid core elements extend substantially along the whole edge of the flat board.

In a further favourable embodiment of the air freight pallet according to the invention the pallet edge part and the pallet wall part are substantially wholly of plastic materials, preferably plastic materials based on one of polypropylene and polyethylene. Examples of polypropylene-based materials are polypropylene reinforced with glass fibres and polypropylene reinforced with polypropylene fibres.

A further favourable embodiment of the air freight pallet according to the invention also comprises a fixation system for fixing goods on the air freight pallet. In this embodiment of the air freight pallet according to the invention it is possible to fix goods on the air freight pallet by means of for instance tensioning belts which are attached to the fixation system and tensioned over the goods.

In a favourable embodiment hereof the fixation system comprises a number of rails which are fixed to the pallet edge part. This embodiment is a particularly simple embodiment. In a further embodiment hereof the rail is of aluminium. Aluminium is highly suitable for this specific component of the air freight pallet according to the invention. This measure moreover has the advantage that the fixation system is largely the same as existing fixation systems, contributing toward the acceptance of the air freight pallet according to the invention. In an alternative embodiment hereof the fixation system is of a plastic material.

In a further favourable embodiment of an air freight pallet according to the invention with solid core elements in the pallet edge part and a number of rails fixed to the pallet edge part, the rails are fixed by means of fixing members which extend through at least part of the solid core elements. This measure enables a particularly firm fixing of the rails to the pallet edge part.

In a further favourable embodiment hereof the solid core elements extend over an extension distance from the edge of the flat board into the core of the flat board transversely of the edge in the plane of extension of the flat board, wherein the extension distance is greater close to the position of the fixing members than close to a position between two successive fixing members. This measure enables a particularly favourable distribution of the forces which are transmitted via the fixing members to the pallet edge part when the rails are loaded.

In a particularly favourable embodiment hereof the core layer extends under the rails close to the position between two successive fixing members. This measure enables a direct transmission of forces from the rails to the stiff core layer.

In a favourable embodiment of an air freight pallet according to the invention, wherein solid core elements are elongate elements which extend in the longitudinal direction thereof along a part of the edge of the flat board, the side of the core elements remote from the edge of the flat board in the plane of extension of the flat board follows a wave pattern, so that the width of the core elements alternately increases gradually and decreases gradually in the plane of extension of the flat board along the longitudinal direction of the core elements. This measure enables a particularly favourable distribution of the forces transmitted via the fixing members to the pallet edge part when the rails are loaded, in the case where elongate solid core elements extending along a part of the edge of the flat board are applied.

A further favourable embodiment of the air freight pallet according to the invention also comprises corner elements which are mounted on the pallet edge part at the corners of the air freight pallet. This measure enables a strengthening of the corners of the air freight pallet. In a favourable embodiment hereof the corner elements are mounted releasably on the pallet edge part. This measure makes it possible to replace corner elements which no longer function as required, being for instance worn or broken. A favourable material for the corner elements is solid nylon. It is however also possible to embody the corner elements from solid steel, or aluminium.

In a favourable embodiment of an air freight pallet according to the invention with solid core elements and corner elements, the corner elements protrude partially into recesses in the core elements. This measure enables a particularly robust connection of the corner elements to the pallet edge part.

In an alternative embodiment of the air freight pallet according to the invention with a fixation system, the pallet edge part comprises the fixation system. For instance in that the fixation system, for instance a fixation rail, is received in a recess in the pallet edge part, or in that the fixation system and the pallet edge part form a unit. In the latter case the fixation system can be formed in the material of the pallet wall part.

In a further embodiment of the air freight pallet according to the invention, the pallet edge part and the pallet wall part are two separate components which are mutually connected. This embodiment forms an alternative to the embodiment of the air freight pallet according to the invention wherein the pallet wall part and the pallet edge part are formed integrally. This embodiment is favourable if, for instance due to specific requirements being set for the pallet edge part or pallet wall part, integral forming of the pallet edge part and the pallet wall part is not possible or not desired.

In a further embodiment of the air freight pallet according to the invention, wherein the pallet edge part and the pallet wall part are two separate components, at least one of the pallet wall part and the pallet edge part comprises a core on which a layer of plastic material is arranged as surface. In a further embodiment hereof at least one of the core layers is of plastic material. In a further or alternative embodiment hereof at least one of the other core layers is of a different plastic material.

In a further embodiment of the air freight pallet according to the invention, wherein the pallet edge part and the pallet wall part are two separate components, at least one of the pallet wall part and the pallet edge part is constructed substantially wholly from layers of plastic material, and preferably both of them.

In a further embodiment of the air freight pallet according to the invention, wherein the pallet edge part and the pallet wall part are two separate components, the plastic material comprises a plastic basic material which is reinforced with fibres. In a further embodiment hereof the plastic basic material and the fibres are both of polypropylene.

In a further embodiment of the air freight pallet according to the invention, wherein the pallet edge part and the pallet wall part are two separate components, the pallet wall part and the pallet edge part are at least connected by means of a plastic weld.

In a further embodiment of the air freight pallet according to the invention the pallet wall part comprises a drainage hole. This measure makes it possible to drain for instance rainwater falling onto the pallet. This has the advantage that the rainwater does not remain on the pallet, and so cannot for instance damage the goods placed thereon.

In a further embodiment of the air freight pallet according to the invention, wherein the pallet edge part and pallet wall part are two separate components, the air freight pallet also comprises a fixation system for fixing goods on the air freight pallet. In a further embodiment hereof the pallet edge part comprises the fixation system. In a further embodiment hereof the fixation system is received in a recess in the pallet edge part. In an alternative embodiment the fixation system and the pallet edge part form a unit.

The present invention also relates to a method for manufacturing an air freight pallet, comprising the steps of:
forming a pallet wall part and a pallet edge part on the pallet wall part; wherein
at least one of the pallet edge part and the pallet wall part comprises a number of layers of a plastic material.

This method for manufacturing an air freight pallet enables relatively simple manufacture of an air freight pallet. Compared to the aluminium from which the pallet edge part and the pallet wall part of the known air freight pallets is manufactured, plastic materials are easy to compose from specific plastic components in order to realize a material with the desired properties. In addition, plastic materials are easy to process and different plastic materials, as well as the same plastic materials with a different structure, are easily combined to form one whole. This makes it possible to manufacture an air freight pallet in relatively simple manner with the method according to the invention, wherein the pallet edge part and the pallet wall part are adapted specifically to the function thereof.

In a favourable embodiment of the method according to the invention the forming of the pallet wall part and a pallet edge part on the pallet wall part comprises the steps of:
providing a flat board, wherein the core of the flat board comprises a core layer with an open structure, preferably of a plastic material, and a surface layer is arranged as surface on the core, preferably a surface layer of a plastic material, more preferably a fibre-reinforced plastic material; and
transforming the edge part of the flat board into the pallet edge part, wherein the pallet wall part is formed by the central part of the flat board enclosed by the pallet edge part.

This embodiment of the method according to the invention makes it possible to make use of a starting material in integral form for the purpose of forming therefrom an air freight pallet according to the invention with a pallet edge part and a pallet wall part. This has the advantage for instance that relatively little starting material need be held in stock. With this embodiment of the method according to the invention method steps for connecting the pallet wall part and the pallet edge part are moreover avoided, with the advantage that the method is simplified. During transformation of the edge part of the flat board particularly the open structure of the core layer enables a particularly simple forming of the pallet edge part. Compared to a core layer with a solid structure, little energy is thus required to deform the edge part of the flat board or to remove material from the edge part of the flat board. The use of plastic material for the core layer and/or the surface layer for instance makes a deformation of the edge part of the flat board possible by means of thermoforming in a mould, wherein the volume of the core layer is reduced and the surface layer around the core layer remains intact. This enables a particularly effective and simple formation of the pallet wall part from the edge part of the flat board.

In a favourable embodiment of the method according to the invention the transformation of the edge part of the flat board to the pallet edge part comprises of adding a number of solid core elements to the core thereof along the edge of the flat board. Exceptionally simple strengthening of the pallet edge part relative to the pallet wall part is hereby possible during the manufacture of a pallet wall part and a pallet edge part from a starting material taking a simple form, such as a flat board. The use of solid core elements of plastic material particularly make it possible to compose a plastic material which is for instance easy to process or can for instance be readily connected to the material of further elements of the air freight pallet.

In a favourable embodiment of the method according to the invention, wherein core elements are added to the core of the flat board, the step of adding a number of core elements to the core of the flat board comprises the steps of:
arranging a number of recesses in the core layer with an open structure;
arranging the solid core elements in the recesses; and
connecting the solid core elements to the core layer.

This embodiment enables simple placing of the core elements in the core layer of the flat board. Particularly arranging a recess along substantially the whole edge of the board and placing a number of elongate core elements therein in the longitudinal direction thereof along the edge of the board enables an exceptionally simple forming of the pallet edge part.

In a favourable embodiment of the method according to the invention, wherein solid core elements are arranged in recesses in the core layer, the recesses are arranged in the core layer with an open structure from a side surface of the flat board. This embodiment of the method according to the invention makes possible a very simple arrangement of the recess, wherein little material is removed.

In an alternative embodiment of the method according to the invention, wherein solid core elements are added to the core layer of the flat board, the step of adding a number of core elements to the core of the board-like element comprises the steps of:
arranging the solid core elements against the core layer with an open structure on a side surface of the flat board; and
arranging an additional surface layer, preferably of a plastic material, more preferably fibre-reinforced plastic material, round the solid core elements and a part of the surface of the flat board, so that the solid core elements are enclosed.

This embodiment makes it possible to add the solid core elements to the core layer of the flat board without recesses being made in the core layer. This can be advantageous, for instance if arranging such recesses is impossible or undesirable.

In a further, more favourable embodiment of the method according to the invention the transformation of the edge part of the flat board into the pallet edge part comprises the step of forming an edge profile on the edge of the board in a mould by means of a thermoforming process. This embodiment enables a particularly effective and simple transformation of the edge part of the flat board into the pallet edge part. This method of transforming the edge part of the flat board is particularly favourable if both the core layer and the surface layer of the flat board are of a plastic material.

Particularly in combination with arranging solid core elements in recesses arranged in the core layer with an open structure from a side surface of the flat boards, transforming the edge part of the flat board by means of a thermoforming process makes it possible, after placing of the core elements in the recesses, to also connect the core elements to the core layer simultaneously with forming of the edge profile. This has the advantage that the number of operations required to perform the method steps can be reduced, this simplifying performing of the method.

In a favourable embodiment hereof the depth of the recesses is greater than the width of the core elements, so that the core elements are enclosed by the core layer during forming of the edge profile.

In a further favourable embodiment a layer of plastic material in the form of a sheet is arranged round the edge of the board before an edge profile is formed on the edge of the flat board in the mould. This makes it possible in simple manner to obtain a smooth and strong surface for the edge of the air freight pallet.

Particularly in combination with arranging the solid core elements against the core layer with an open structure on a side surface of the flat board, the transformation of the edge part of the flat board by means of a thermoforming process makes it possible, after arranging the solid core elements against the core layer with an open structure on a side surface of the flat board and after arranging the surface layer in the form of a sheet round the solid core elements and part of the surface of the flat board, to simultaneously form the edge profile and connect the sheet to the surface of the solid core elements and a part of the surface of the flat board. This has the advantage that the number of operations required to perform the method steps can be reduced, this simplifying performing of the method.

In a favourable embodiment of the method according to the invention, wherein recesses into which the solid core elements are placed are arranged in the core layer with open structure, the recesses are arranged along a part, and preferably the whole length, of the edges of the flat board in a pattern wherein the distance between the edge of the flat board and the core layer in the plane of extension of the flat board alternately increases and decreases, preferably gradually as in a wave pattern, and in the recesses elongate solid core elements are arranged of a form such that the core elements connect to the core layer along the pattern thereof, wherein after connecting of the solid core elements to the core layer the method comprises the step of fixing rails of a fixation system on the pallet edge part using fixing members such that the fixing members extend at least partially in the solid core elements, wherein the steps are performed such that the solid core elements extend over an extension distance from the edge of the flat board into the core of the flat board transversely of the edge in the plane of extension of the flat board, wherein the extension distance is greater close to the position of the fixing members than close to a position between two successive fixing members, and wherein the core layer preferably extends under the rails close to the position between two successive fixing members.

The present invention will be further elucidated hereinbelow on the basis of a number of exemplary embodiments as shown schematically in the accompanying figures. These are non-limitative exemplary embodiments. In the figures:

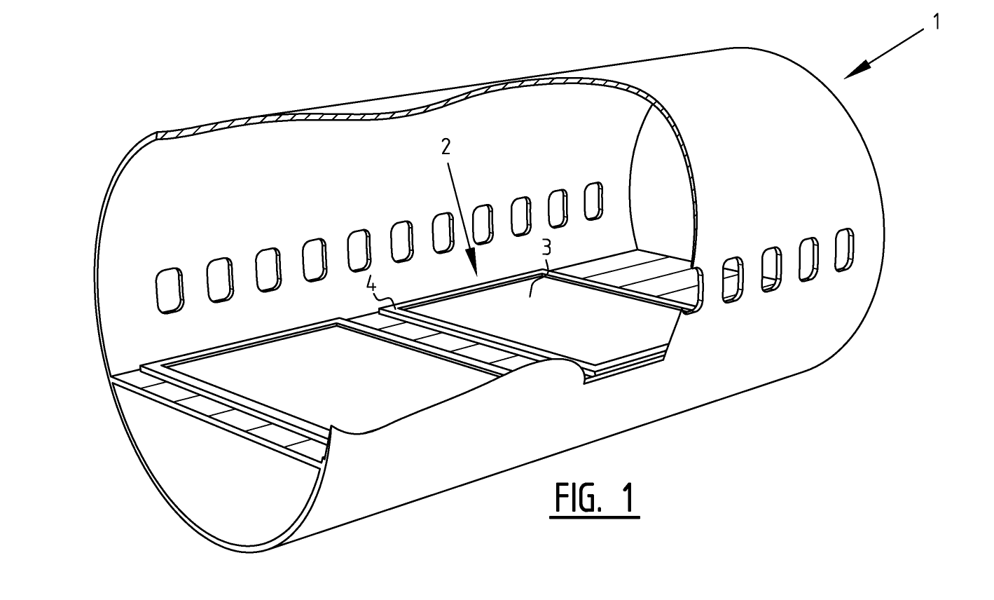

FIG. 1 is a perspective view of a part of a body of an aircraft with an air freight pallet therein;

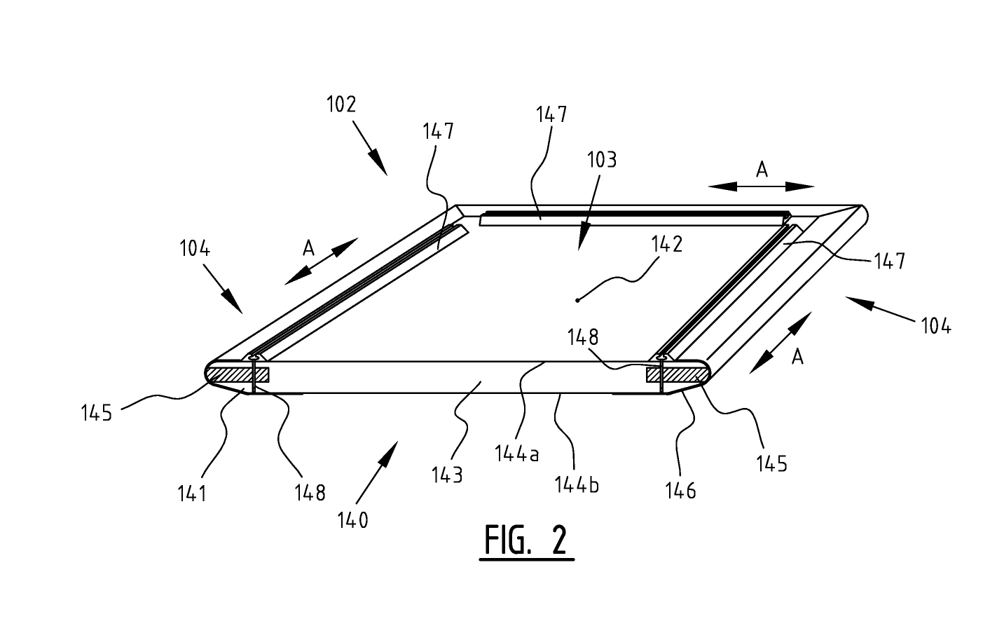

FIG. 2 is a perspective view of an embodiment of an air freight pallet according to the invention;

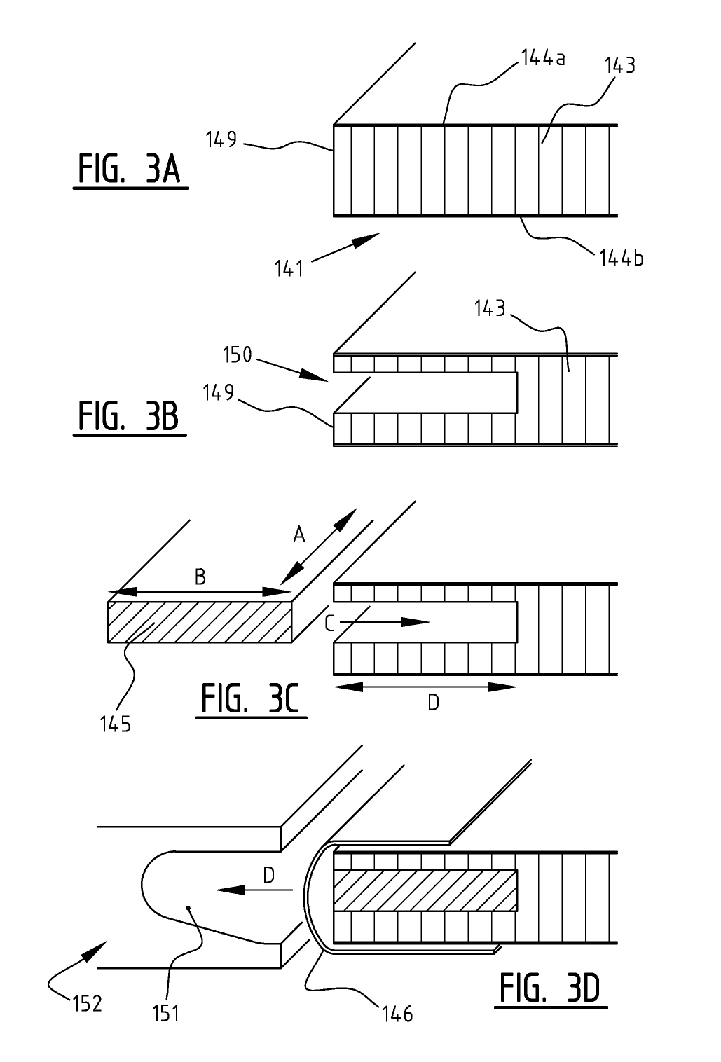

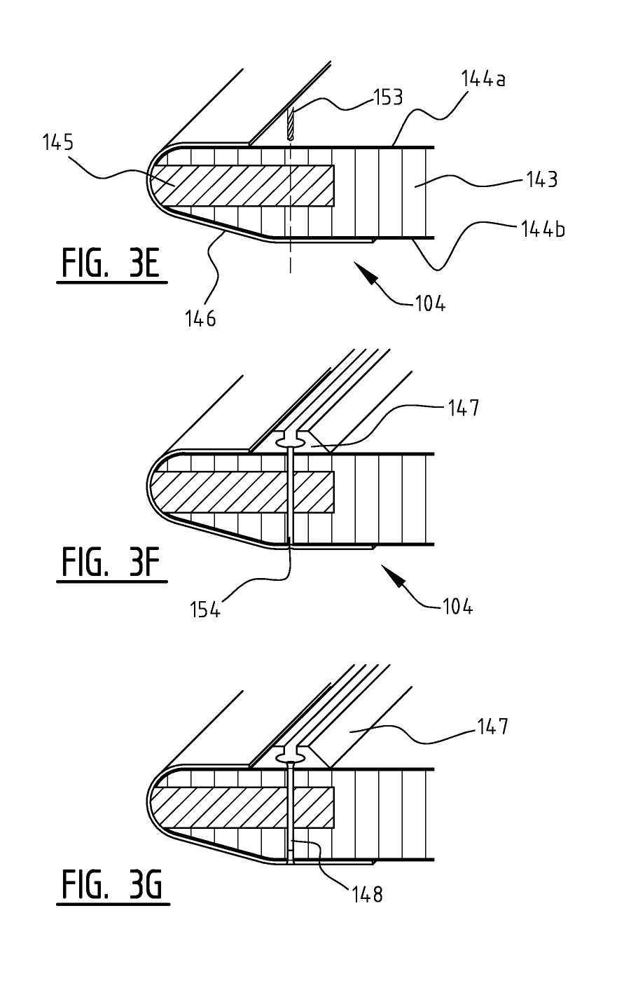

FIG. 3A-3G are perspective views of a cross-section of the edge of a flat board by way of illustrating an embodiment of a method according to the invention for manufacturing the air freight pallet of FIG. 2;

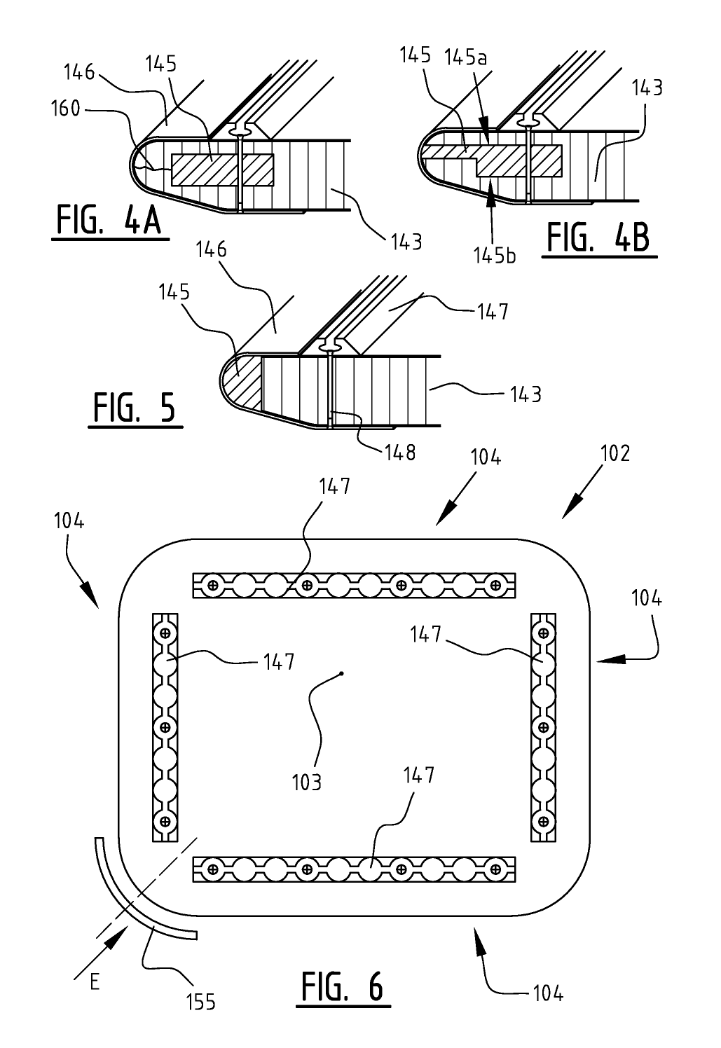

FIGS. 4A and 4B are perspective views of a cross-section of the edge of the flat board by way of illustrating an alternative method to the method as shown in FIGS. 3A-3G;

FIG. 5 is a perspective view of a cross-section of the edge of a flat board by way of illustrating an alternative method to the method as shown in FIGS. 3A-3G;

FIG. 6 is a top view of an air freight pallet manufactured according to the method of FIG. 3;

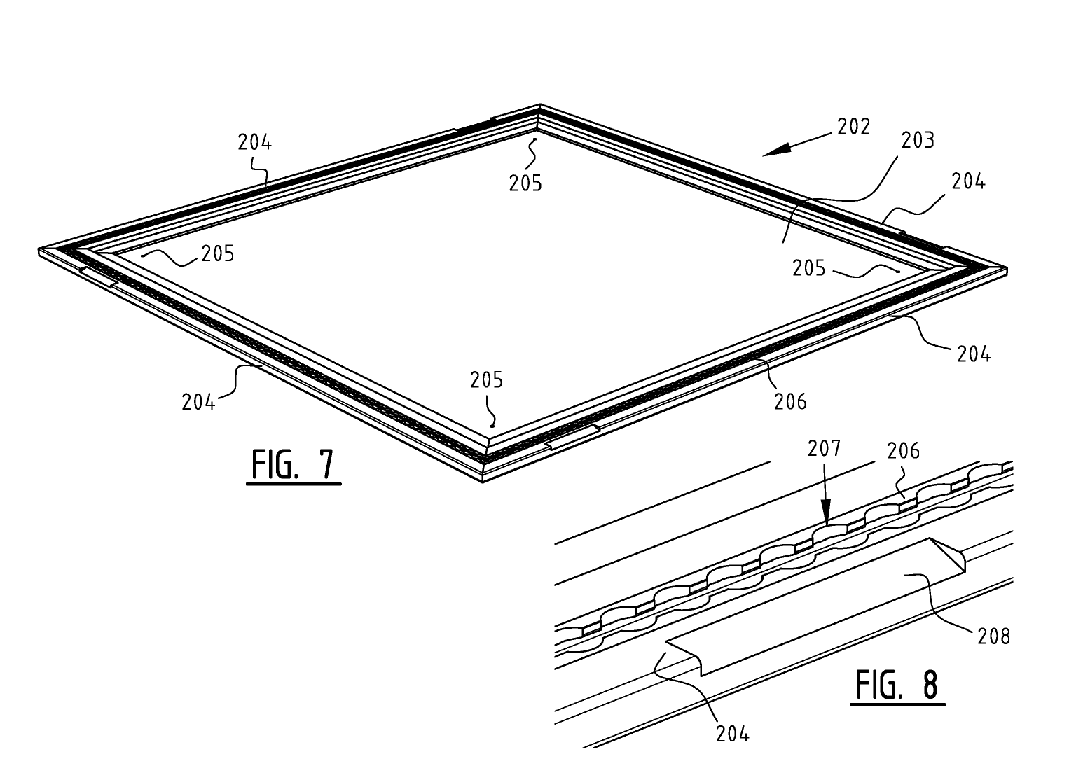

FIG. 7 is a perspective view of an alternative embodiment of the air freight pallet of FIG. 2;

FIG. 8 is a perspective view of a detail of the air freight pallet of FIG. 7;

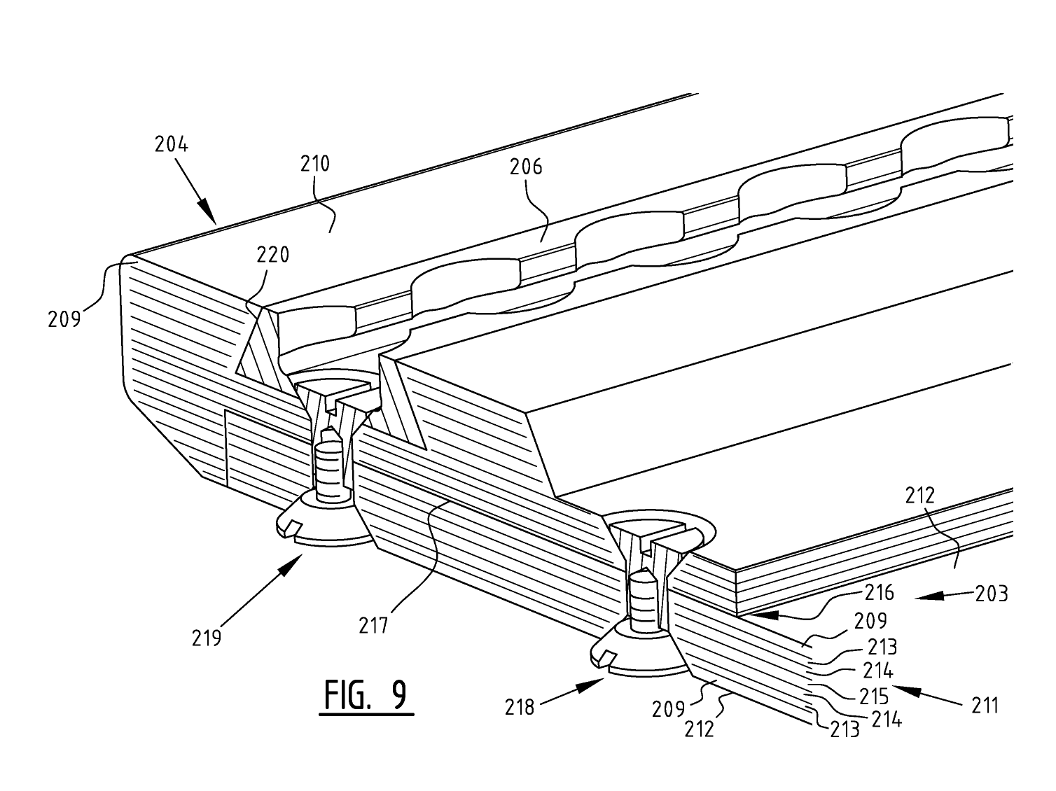

FIG. 9 is a perspective cross-sectional view of a detail of the air freight pallet of FIG. 7;

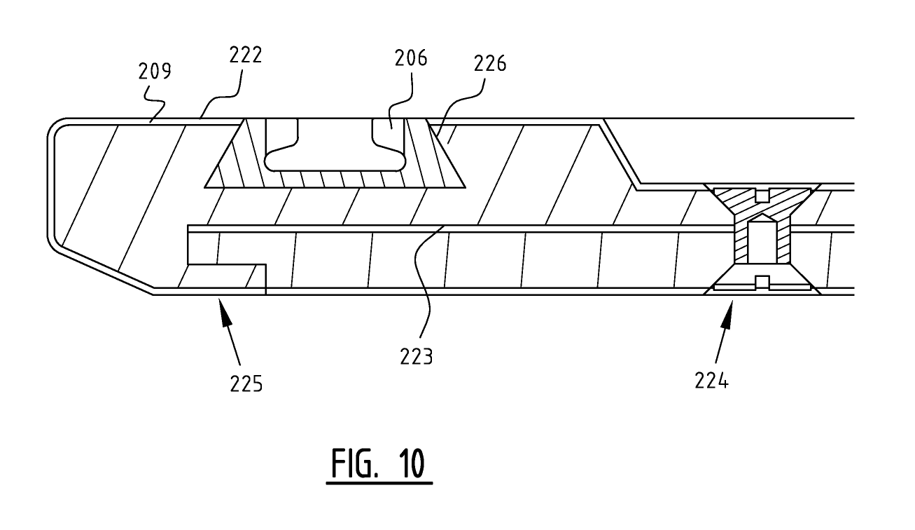

FIG. 10 is a cross-sectional view of an alternative embodiment of the detail of the air freight pallet of FIG. 9;

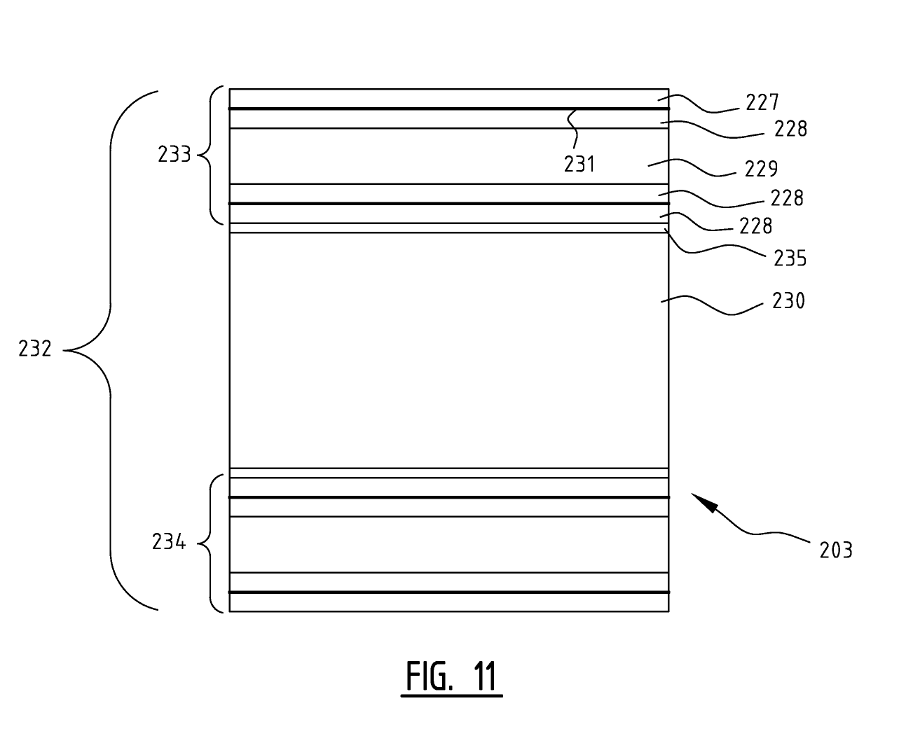

FIG. 11 is a cross-sectional view of an alternative structure of the pallet wall part of FIG. 9;

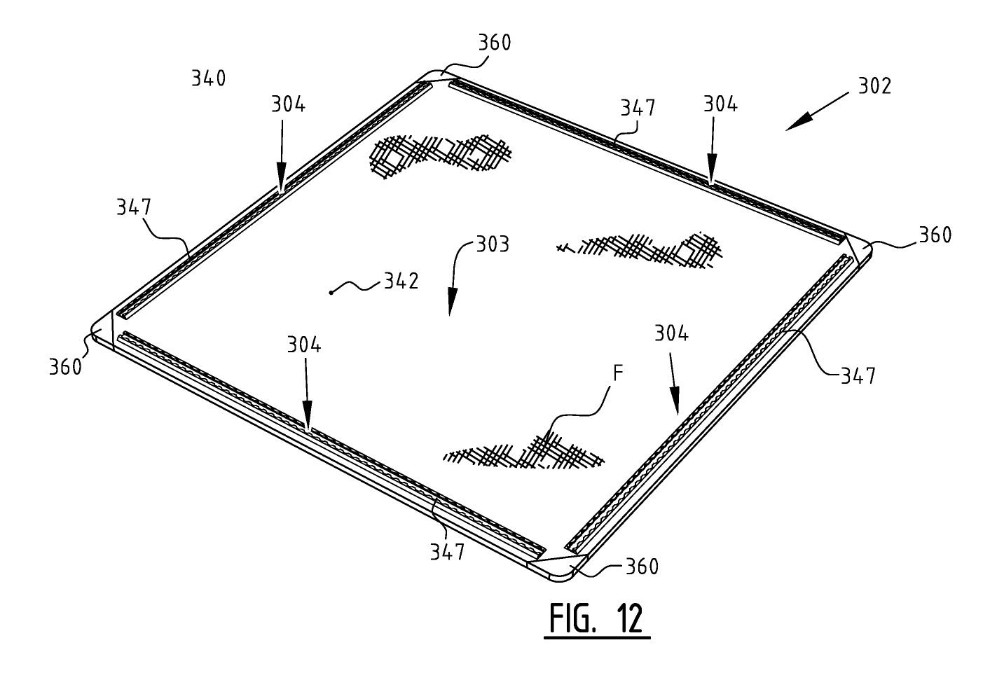

FIG. 12 shows an embodiment of an air freight pallet according to the invention;

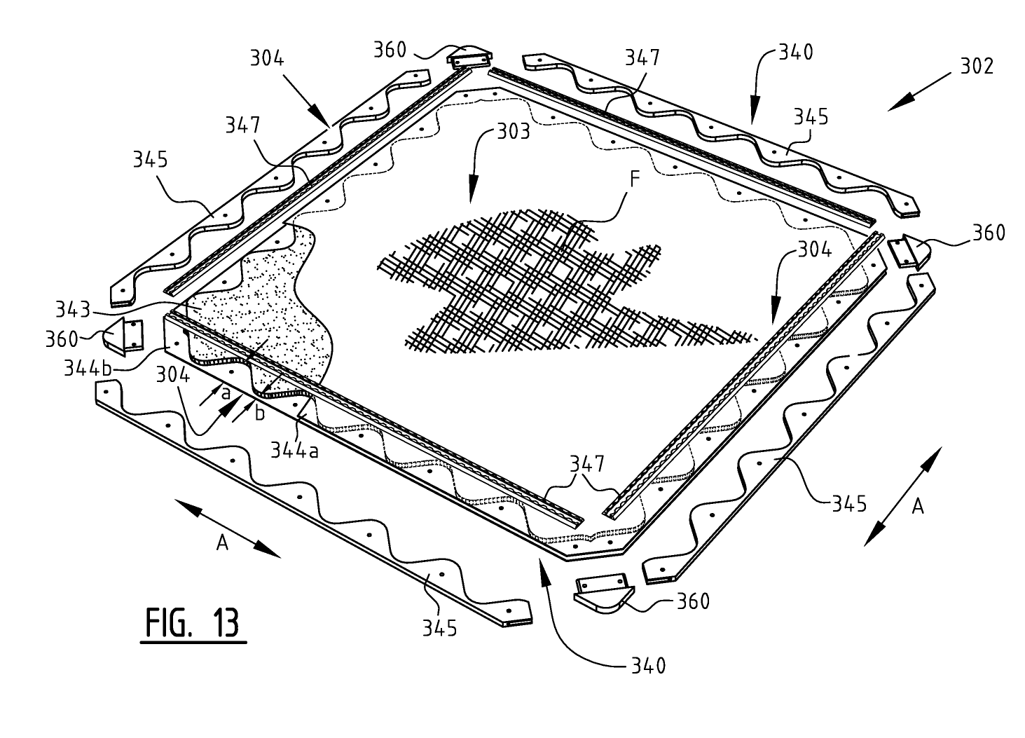

FIG. 13 is a partially cut-away and partially exploded perspective view of the air freight pallet of FIG. 12;

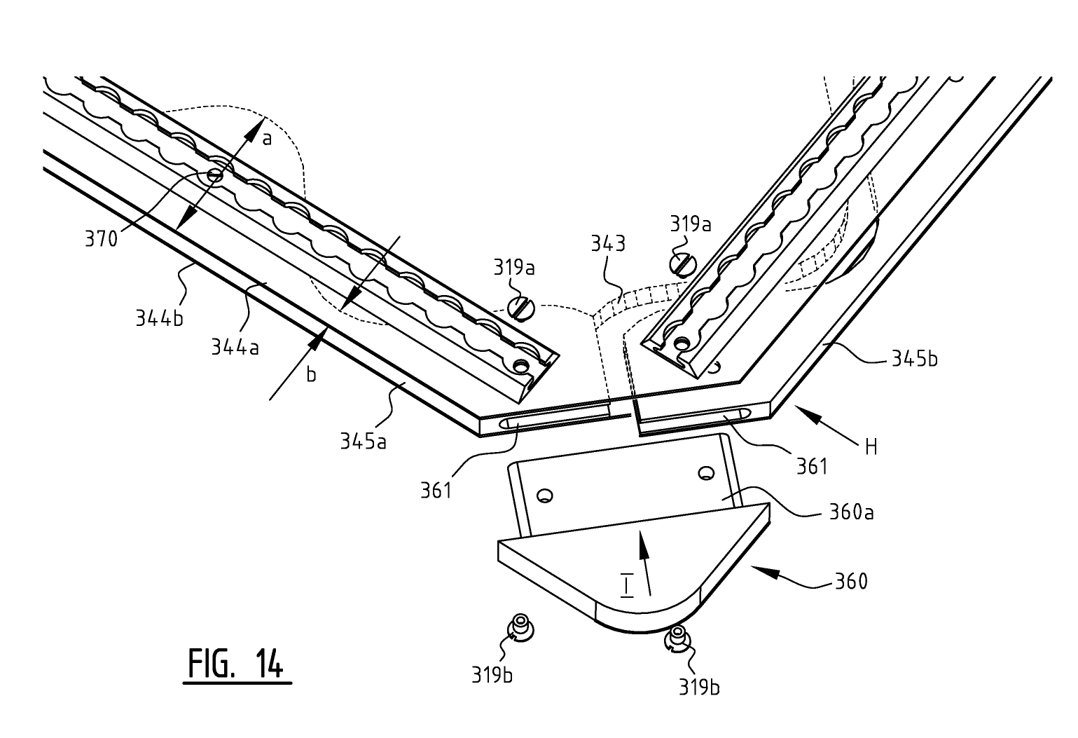

FIG. 14 is a partially cut-away and partially exploded perspective detail view of the construction of one of the corners of the air freight pallet of FIG. 12.

FIG. 1 shows a part of aircraft body 1 with an air freight pallet 2 therein. Air freight pallet 2 is shown with a pallet wall part 3 and a pallet edge part 4 on pallet wall part 3.

FIG. 2 is a perspective cross-sectional view of an embodiment of air freight pallet 102 according to the invention, with a pallet wall part 103 and a pallet edge part 104 on pallet wall part 103.

FIG. 2 shows that pallet edge part 104 and pallet wall part 103 are formed integrally, i.e. from one flat board 140. Pallet edge part 104 is the edge part 141 of flat board 140. Pallet wall part 103 is the central part 142 of flat board 140 enclosed by pallet edge part 104. The core of flat board 140 comprises a core layer 143 with an open structure, in particular a honeycomb structure. Core layer 143 is of a plastic material, particularly polypropylene. A surface layer 144a is arranged on the core of flat board 140 as upper surface and a surface layer 144b as lower surface. Surface layers 144a and 144b are of a fibre-reinforced plastic material, in particular a polypropylene-based plastic material such as glass fibre-reinforced polypropylene.

The core of flat board 140 also comprises along the edge thereof a number of solid core elements 145 of a plastic material, in particular polyethylene. Solid core elements 145 extend into the core layer 143 with the open structure and are elongate elements which extend in the longitudinal direction A thereof along the edge of the flat board. Arranged round the edge of flat board 140 is an additional surface layer 146 of a fibre-reinforced plastic material which extends over a part of surface layers 144a and 144b.

Pallet edge part 104 and pallet wall part 103 of air freight pallet 102 as shown in FIG. 2 are hereby made substantially wholly of plastic materials.

Air freight pallet 102 is also provided with a fixation system for fixing goods on the air freight pallet. The fixation system comprises a number of rails 147 fixed onto pallet edge part 104 by means of fixing members, in the form of bolt/nut combination 148, which extend through solid core elements 145. Rails 147 are manufactured particularly from aluminium.

FIGS. 3A-3G show a method for manufacturing the embodiment of air freight pallet 102 of FIG. 2. In FIG. 3A edge part 141 of flat board 140 shown in FIG. 2 is shown in cross-section before it is transformed into pallet edge part 104. The core of flat board 140 comprises a core layer 143 with an open structure, in particular a honeycomb structure. Surface layers 144a and 144b are arranged as respectively upper and lower surface on the core.

FIGS. 3B-3D show how edge part 141 of flat board 140 is transformed into pallet edge part 104.

FIG. 3B shows that a recess 150 is arranged in core layer 143 from a side surface 149 of the flat board.

FIG. 3C shows that an elongate solid core element 145 is arranged in the longitudinal direction A thereof along the edge of the flat board into recess 150 in the direction of arrow C. The width B of solid core element 145 is equal to the depth D of recess 150.

FIG. 3D shows that an additional surface layer 146 in the form of a sheet of fibre-reinforced plastic material is arranged round the edge of the flat board over a part of surface layers 144a and 144b, and that the edge of the flat board is then carried in the direction of arrow D into a cavity 151 of a mould 152.

FIG. 3E shows that in a thermoforming process an edge profile is formed on the edge of the flat board as a result of heat in cavity 151 of mould 152 and the shape of cavity 151. In this thermoforming process the solid core element 145 and core layer 143 are also connected along the contact surface as a result of the heat, and the additional surface layer 146 is also connected to surface layers 144a and 144b as well as to core element 145 along the contact surface. As a result the solid core element 145 is connected to core layer 143.

FIG. 3E also shows that a hole is drilled through surface layers 144a, 144b and 146, core layer 143 and solid core element 145 by means of a drilling tool 153 so that, as shown in FIG. 3F, a continuous hole 154 is arranged in pallet edge part 104. FIGS. 3F and 3G show that rail 147 of the fixation system is fixed to pallet edge part 104 by means of bolt/nut combination 148, which extends through hole 150.

FIG. 4A shows the result of an alternative method to the method as shown in FIGS. 3A-3G. In performing of the step as shown in 3C a core element 145 is particularly arranged in recess 150 wherein the width B of core element 145 is smaller than the depth D of recess 150. As a result the solid core element 145 is enclosed in core layer 143 during the thermoforming process as shown in FIG. 3D. Shown schematically in FIG. 4 by means of line 160 is that the upper wall and the lower wall of recess 150 are brought together in the thermoforming process. An alternative result is shown in FIG. 4B. In order to arrive at this result there is arranged in recess 150 a solid core element 145 with a recess therein such that solid core element 145 has a width on one side 145a thereof which is equal to the depth of recess 150 and that solid core element 145 has a width on the other side 145b thereof which is smaller than the depth of recess 150. The result is then that after the thermoforming process the core element 145 is enclosed by core layer 143, with the exception of a part of one side.

FIG. 5 shows the result of a further alternative method to the method as shown in FIGS. 3A-3G. In this method solid core elements 145 are not placed in a recess 150 but against side surface 149 of flat board 140. As shown in FIG. 3D, an additional surface layer 146 is then arranged round solid core element 145 and a part of surface layers 144a and 144b, and the whole is placed in the heated cavity 151 of mould 152. Just as in the method wherein the solid elements are placed in a recess, during the thermoforming process in cavity 151 of mould 152 the core layer 143 is then connected to solid core element 145 along the contact surface, the additional surface layer 146 is also connected to surface layers 144a and 144b as well as to the solid core element along the contact surface, and the edge of flat board 140, including core element 145, is provided with an edge profile. When rails 147 are arranged on the pallet edge part the fixing members 148 do not then extend through solid core element 145.

FIG. 6 is a top view of air freight pallet 102 manufactured as according to FIGS. 3A-3G, with pallet wall part 103 and pallet edge part 104, wherein a number of rails 147 of the fixation system are arranged on pallet edge part 104. Also shown is that the corners of air freight pallet 102 can be strengthened by providing these corners with a plate 155 of metal or of plastic material, which can be arranged against the corners in the direction of arrow E.

In an alternative embodiment of the method for manufacturing the air freight pallet according to the invention as shown in FIGS. 3A-3G

FIG. 7 shows an alternative embodiment of the air freight pallet according to the invention. Air freight pallet 202 is shown with pallet wall part 203, which is connected to four pallet edge parts 204. Pallet wall part 203 is shown with drainage holes 205. Pallet edge parts 204 are shown with a fixation system formed by a rail 206 for fixing goods on air freight pallet 202. As shown in FIG. 8, this rail consists of hole-like recesses 207. FIG. 8 also shows that pallet edge part 204 is provided with a recessed portion 208 on which or in which an identification number can for instance be arranged. This indication number is better protected by being arranged in a recessed portion 208.

FIG. 9 shows that pallet edge part 204 is wholly constructed from layers of a plastic material 209. The surface 210 of pallet edge part 204 is thereby made of the plastic material. Pallet wall part 203 consists of a core 211 on which a layer of the plastic material 209 is arranged, this layer forming surface 212 of pallet wall part 203. A highly suitable plastic material for the layer of the plastic material 209 consists for instance of a plastic basic material reinforced with fibres, wherein both the plastic basic material and the fibres are of polypropylene. Such a plastic material is for instance known under the name CURT and is from the Propex company. FIG. 9 further shows that core 211 of pallet wall part 203 is assembled from core layers 213, 214, 215. Core layer 213 is of the same plastic material as the layer of the plastic material 209 on surface 212 of pallet wall part 203. Core layers 214 and 215 consist of a different plastic material, wherein core layer 215 has a honeycomb structure.

Pallet wall part 203 and pallet edge part 204 are mutually connected by means of a plastic weld 216, which is realized by means of for instance an ultrasonic welding method, an adhesive between the surfaces 217 making mutual contact and screw connections 218 and 219. Screw connection 219 also holds rail 206 of the fixation system in place. This rail 206 is received in a recess 220 in pallet edge part 204. This rail 206 of the fixation system is for instance of aluminium, of the same plastic material as the layer of plastic material 209 or of another plastic material.

FIG. 10 shows an alternative embodiment of air freight pallet 202. Pallet edge part 203 is shown here with a core 221 on which a layer of plastic material 209 is arranged, this layer 209 forming surface 222 of pallet edge part 203. Pallet wall part 103 and pallet edge part 204 are mutually connected by means of an adhesive between the surfaces 223 making mutual contact, screw connection 224 and tongue and groove connection 225. Rail 206 of the fixation system is received in a recess 226 in pallet edge part 204.

FIG. 11 shows a structure of layers which has been found highly suitable for a pallet wall part according to the invention. The shown pallet wall part 203 consists of a core with core layers 228, 229, 230, 235, on which a layer of the plastic material 227 is arranged. This layer 227 forms the surface of pallet wall part 203. The shown laminate 232 is symmetrical, wherein core layer 230 forms the centre.

The layer of the plastic material 227 consists of a plastic basic material reinforced with fibres, wherein both the plastic basic material and the fibres are of polypropylene, such as CURV from the Propex company. Of the core layers, core layers 228 are of the same material as layer 227. Layer 227 is connected to the core layer 228 directly adjacent thereof by means of an adhesive layer 131. The core layers 228 directly adjacent of each other are also connected by means of such an adhesive layer. Core layers 229, 230 and 235 are made from a different plastic material than the plastic material of layer 227 and core layers 228. Core layer 229 is of a material known under the name TWINTEX and from the Saint-Gobain Vetrotex company. Core layer 235 is made of polyester. Core layer 230 is of polypropylene and has a honeycomb structure.

Layers 227, 228 and 229 also form per se a symmetrical laminate 233, 234. Laminate 232 can be seen as layer 230, on either side of which laminates 232 and 234 are arranged by means of connecting layer 235.

In FIGS. 7-11 the fixation system is shown as a rail received in a recess of the pallet edge part. The fixation system can also form a unit with the pallet edge part. Fixing recesses for instance can then be cut from the pallet edge part. The pallet edge part can for instance also be realized integrally by means of for instance a co-extrusion with two plastic materials. The pallet edge and the fixation system can also be glued such that they form a mechanical unit. The fixation system can also be received in the pallet wall part. The fixation system can also take a different form, for instance folding pad eyes, differently shaped recesses, flexible loops and the like. The fixation system can also be arranged not in a recess but on the surface of the pallet edge part or the surface of the pallet wall part, for instance by means of adhesive or screws, or by means of a combination thereof.

In FIGS. 7-11 the core of the pallet wall part is assembled wholly from core layers of a plastic material. One of the core layers can for instance also comprise a material other than plastic, for instance aluminium.

In FIGS. 7-11 the core of the pallet wall part is assembled from five layers. The core can also be assembled from more or fewer layers.

In FIGS. 7-11 the pallet wall part is assembled from more than one plastic material. The pallet wall part can also be assembled from one plastic material.

In FIGS. 7-11 the pallet wall part and the pallet edge part are connected using different connecting means. The pallet wall part and the pallet edge part can also be connected using more or fewer different connecting means. The pallet edge part and the pallet wall part can also be connected in the sense that they are formed by connecting a plastic, for instance polypropylene, cord or rod by means of plastic fibre mats to the edge of a plastic board and forming the whole of the mats, the cord or the rod and the edge of the plastic board into the pallet edge part, for instance by means of a thermoforming process, wherein the rest of the plastic board forms the pallet wall part connected to the pallet edge part, as shown in FIGS. 3A-3G and described in relation thereto.

FIG. 12 shows an embodiment of an air freight pallet 302 according to the invention with a pallet wall part 303 and a pallet edge part 304 on pallet wall part 303.

Shown in FIG. 12 is that pallet edge part 304 and pallet wall part 303 are formed integrally, i.e. from one flat board 340. Pallet edge part 304 is the edge part 341 of flat board 340. Pallet wall part 303 is the central part 342 of flat board 340 which is enclosed by pallet edge part 304. The corners of air freight pallet 302 are formed by means of corner elements 360. As shown schematically in FIG. 12 by means of hatching F, the surface of flat board 340 is formed by the surface of a layer of fibre-reinforced plastic material. Air freight pallet 302 is also provided with a fixation system for fixing goods on the air freight pallet. The fixation system comprises a number of rails 347 fixed onto pallet edge part 304.

FIG. 13 shows a schematic, partially cut-away and partially exploded view of the specific structure of air freight pallet 302 of FIG. 12.

Shown in FIG. 13 is that air freight pallet 302 is formed from a flat board 340 with a core comprising a core layer 343 with an open structure, in particular a honeycomb structure. Core layer 143 is of a plastic material, in particular of polypropylene. A surface layer 344a is arranged on the core of flat board 340 as upper surface and a surface layer 344b as lower surface. Surface layers 344a and 344b are of a fibre-reinforced plastic material, in particular a polypropylene-based plastic material such as glass fibre-reinforced polypropylene. That surface layer 344a is of a fibre-reinforced plastic material is shown schematically in FIG. 13 by means of hatching F. A protective coating can be applied to surface layers 344a and 344b, for instance to form a wearing layer.

FIG. 13 further shows that along the edges of flat board 340 in the core thereof, and particularly in core layer 343 with the open structure, there are arranged recesses in which are placed solid core elements 345 of a plastic material, in particular polyethylene. The solid core elements 345 extend into the core and are elongate elements which extend in the longitudinal direction A thereof along the edge of the flat board. As shown, the sides of core layer 343 of flat board 340 and the core elements 345 directed toward each other follow an undulating wave pattern so that the solid core elements 345 alternately extend in core layer 343 from the edge of flat board 340 in the direction of the plane of extension of core layer 343 over a greater distance, maximum distance a, and a shorter distance, minimum distance b. As shown, holes are arranged through surface layers 344a and 344b and core elements 345, at positions along the edge of flat board 340 where core elements 345 extend over a greater distance in core layer 343, through which holes can be placed fixing members with which rails 347 are fixed to the part of flat board 340 forming the pallet edge part. The holes are particularly positioned at a distance of about half the distance a from the edge of flat board 340 and, as seen in the extending direction of core elements 345, roughly at the position where the flat core elements extend over the maximum distance a in core layer 343, in other words roughly at the position of the crests of the wave pattern of the side of core elements 345 or roughly at the position of the troughs of the wave pattern of the side of core layer 343. The mounting of corner elements 360 is shown in detail in FIG. 14.

FIG. 14 shows in detail a corner of flat board 340 of FIG. 13. A first core element 345a is shown in the situation where it is placed in the recess in core layer 343 between surface layers 344a and 344b. A second core element 345b is shown while being placed in the direction of arrow H into the recess in core layer 343. Further shown is that core elements 345a and 345b are also provided with a recess 361 at the ends thereof facing toward each other. A part 360a of corner element 360 can be placed in the direction of arrow I into this recess 361. In the shown embodiment of the air freight pallet holes are arranged in the part 360a of corner element 360 to be placed into the recesses in core elements 345a and 345b, which holes, when the two core elements 345a and 345b have been arranged in the recesses in core layer 343, corner element 360 has been placed in recesses 360 in core elements 345a and 345b and rails 347 have been positioned on surface layer 344a, form together with holes in surface layers 344a and 344b and holes in rails 347 continuous holes through which the fixing members in the form of bolt 319a/nut 319b combinations can be placed in order to fix both rails 347 and corner element 60 to pallet edge part 304.

FIG. 14 also shows that core layer 343 extends under the rail close to the position between two successive fixing members, in FIG. 14 between bolt 370 and bolt 319a. This is possible because the solid core element 345a extends over a greater distance a in core layer 343 close to bolt 370, and over a lesser distance b close to the position between the two successive fixing members.

In the shown exemplary embodiment of the air freight pallet in FIGS. 12-14, both rails 347 and corner elements 360 can be detached from pallet edge part 304 by unscrewing the fixing members formed as bolt/nut combination, after which for instance rails or corner elements not functioning as required can be replaced by rails or corner elements which do function as required.

Air freight pallet 340 as shown in FIGS. 12-14 can be manufactured by means of the method as shown in FIGS. 3A-3G. Although not shown in FIG. 13, an additional surface layer of a fibre-reinforced plastic material, which extends over a part of surface layers 144a and 144b, can here be placed round the edge of flat board 340 after core elements 345 have been placed in the recesses in core layer 343.

Pallet edge part 304 and pallet wall part 303 of air freight pallet 302 as shown in FIGS. 12-14 are made substantially wholly from plastic materials. With the exception of rails 347 of aluminium and the fixing members for fixing rails 347 onto pallet edge part 304, air freight pallet 302 as shown in FIGS. 12-14 is made substantially wholly from plastic materials.

In FIGS. 9 and 11 the layer structure of the pallet wall part is symmetrical, although this layer structure can also be asymmetrical.

FIG. 3A shows that the core of the flat board consists of one layer with an open structure. The core can also be constructed from more layers, also including layers with a closed structure.

Described with reference to FIGS. 2-5 is that the solid core elements are elongate elements which extend in the longitudinal direction thereof along the edge of the flat board. The solid core elements can also be designed otherwise, for instance as non-elongate elements which are each placed in their own recess along the edge of the flat board.

Described with reference to FIGS. 2-4 is that the solid core elements are arranged in a number of recesses arranged in the core layer with an open structure from a side surface of the flat board. It is also possible to arrange the recesses in the upper or lower surface of the flat board.

The figures show embodiments of the air freight pallet wherein the pallet edge part and the pallet wall part are made entirely of plastic materials. It is also possible for the pallet edge part and the pallet wall part to comprise non-plastic materials. In addition to a core layer with an open structure of plastic material, the core of the pallet wall part can for instance thus comprise a core layer of aluminium.

Although the fixation system is embodied as rails in the figures, this being a preferred embodiment, the fixation system can also be embodied in other manner, for instance as separate fixing eyes arranged on the pallet edge part and/or pallet wall part.

1. Air freight pallet, comprising
a pallet wall part; and
a pallet edge part on the pallet wall part; wherein
at least one of the pallet edge part and the pallet wall part comprises a number of layers of a plastic material.

2. Air freight pallet as claimed in claim 1, wherein
the pallet edge part and the pallet wall part are formed integrally.

3. Air freight pallet as claimed in claim 2, wherein
the pallet edge part is the edge part of a flat board; and
the pallet wall part is the central part of the flat board enclosed by the pallet edge part; wherein
the core of the flat board comprises a core layer with an open structure, preferably of a plastic material, and a surface layer is arranged as surface on the core, preferably a surface layer of a plastic material, more preferably a fibre-reinforced plastic material.

4. Air freight pallet as claimed in claim 3, wherein
the core of the flat board also comprises a number of solid core elements, preferably of a plastic material, along the edge of the flat board.

5. Air freight pallet as claimed in claim 4, wherein
the solid core elements extend in the core layer with the open structure, wherein the solid core elements preferably extend wholly in the core layer and wherein the solid core elements are more preferably enclosed by the core layer.

6. Air freight pallet as claimed in claim 4, wherein
the solid core elements are elongate elements which extend in the longitudinal direction thereof along a part of the edge of the flat board, preferably along substantially the whole edge of the flat board.

7. Air freight pallet as claimed in claim 1, wherein the pallet edge part and the pallet wall part are substantially wholly of plastic materials, preferably plastic materials based on one of polypropylene and polyethylene.

8. Air freight pallet as claimed in claim 1, wherein the air freight pallet also comprises a fixation system for fixing goods on the air freight pallet.

9. Air freight pallet as claimed in claim 8, wherein the fixation system comprises a number of rails which are fixed to the pallet edge part.

10. Air freight pallet as claimed in claim 4, wherein the rails are fixed by means of fixing members which extend through at least part of the solid core elements.

11. Air freight pallet as claimed in claim 10, wherein the solid core elements extend over an extension distance from the edge of the flat board into the core of the flat board transversely of the edge in the plane of extension of the flat board, wherein the extension distance is greater close to the position of the fixing members than close to a position between two successive fixing members.

12. Air freight pallet as claimed in claim 11, wherein the core layer extends under the rails close to the position between two successive fixing members.

13. Air freight pallet as claimed in claim 6, wherein the side of the core elements remote from the edge of the flat board in the plane of extension of the flat board follows a wave pattern, so that the width of the core elements alternately increases gradually and decreases gradually in the plane of extension of the flat board along the longitudinal direction of the core elements.

14. Air freight pallet as claimed in claim 1, also comprising corner elements which are mounted on the pallet edge part, and preferably mounted releasably on the pallet edge part, at the corners of the air freight pallet.

15. Air freight pallet as claimed in claim 4, wherein the corner elements protrude partially into recesses in the core elements.

16. Air freight pallet as claimed in claim 8, characterized in that the pallet edge part comprises the fixation system.

17. Air freight pallet as claimed in claim 1, wherein the pallet edge part and the pallet wall part are two separate components which are mutually connected.

18. Method for manufacturing an air freight pallet, comprising the steps of:
forming a pallet wall part and a pallet edge part on the pallet wall part; wherein
at least one of the pallet edge part and the pallet wall part comprises a number of layers of a plastic material.

19. Method as claimed in claim 18, wherein the forming of the pallet wall part and a pallet edge part on the pallet wall part comprises the steps of:
providing a flat board, wherein the core of the flat board comprises a core layer with an open structure, preferably of a plastic material, and a surface layer is arranged as surface on the core, preferably a surface layer of a plastic material, more preferably a fibre-reinforced plastic material; and
transforming the edge part of the flat board into the pallet edge part, wherein the pallet wall part is formed by the central part of the flat board enclosed by the pallet edge part.

20. Method as claimed in claim 19, wherein
the transformation of the edge part of the flat board into the pallet edge part comprises of adding a number of solid core elements to the core thereof along the edge of
the flat board, preferably solid core elements of a plastic material.

21. Method as claimed in claim 20, wherein the addition of a number of core elements to the core of the flat board comprises the steps of:
arranging a number of recesses in the core layer with an open structure;
arranging the solid core elements in the recesses; and
connecting the solid core elements to the core layer.

22. Method as claimed in claim 21, wherein
the recesses are arranged along substantially the whole edge of the board and the core elements are elongate elements which are placed in the longitudinal direction thereof along the edge of the board into the recesses.

23. Method as claimed in claim 21, wherein the recesses are arranged in the core layer with an open structure from a side surface of the flat board.

24. Method as claimed in claim 20,
wherein the addition of a number of core elements to the core of the board-like element comprises the steps of:
arranging the solid core elements against the core layer with an open structure on a side surface of the flat board; and
arranging an additional surface layer, preferably of a plastic material, more preferably fibre-reinforced plastic material, round the solid core elements and a part of the surface of the flat board, so that the solid core elements are enclosed.

25. Method as claimed in claim 19, wherein
the transformation of the edge part of the flat board into the pallet edge part comprises the step of forming an edge profile on the edge of the flat board in a mould by means of a thermoforming process

26. Method as claimed in claim 23, wherein
the step of forming the edge profile on the edge of the flat board is performed after placing of the solid core elements in the recess, and the solid core elements are also connected to the core layer during performing of the step of forming the edge profile on the edge of the board.

27. Method as claimed in claim 26, wherein
the depth of the recesses is greater than the width of the core elements, so that the core elements are enclosed by the core layer during forming of the edge profile.

28. Method as claimed in claim 25, also comprising the step of arranging an additional surface layer, preferably of a plastic material, more preferably fibre-reinforced plastic material, in the form of a sheet round the edge of the board before forming an edge profile on the edge of the board in the mould.

29. Method as claimed in claim 24, wherein
the step of forming the edge profile on the edge of the board is performed after arranging of the solid core elements against the core layer with an open structure on a side surface of the flat board, and after arranging the additional surface layer in the form of a sheet round the solid core elements and a part of the surface of the flat board, wherein during performing of the step of forming the edge profile on the edge of the board the sheet is connected to the surface of the solid core elements and a part of the surface of the flat board.

30. Method as claimed in claim 21, wherein the recesses are arranged along a part, and preferably the whole length, of the edges of the flat board in a pattern wherein the distance between the edge of the flat board and the core layer in the plane of extension of the flat board alternately increases and decreases, preferably gradually as in a wave pattern; and wherein in the recesses elongate solid core elements are arranged of a form such that the core elements connect to the core layer along the pattern thereof; and wherein after connecting of the solid core elements to the core layer the method comprises the step of fixing rails of a fixation system on the pallet edge part using fixing members such that the fixing members extend at least partially in the solid core elements;
wherein the steps are performed such that the solid core elements extend over an extension distance from the edge of the flat board into the core of the flat board transversely of the edge in the plane of extension of the flat board, wherein the extension distance is greater close to the position of the fixing members than close to a position between two successive fixing members, and wherein the core layer preferably extends under the rail close to the position between two successive fixing members.
